(19) United States
(12) Patent Application Publication
(10) Pub. No.: US 2025/0369628 A1
(43) Pub. Date: Dec. 4, 2025

(54) SYSTEM AND METHOD FOR REMOVING GREASE FROM A RANGE HOOD SYSTEM

(71) Applicant: Kensol AutoMist LLC, Coplay, PA (US)

(72) Inventors: William Ehritz, Coplay, PA (US); Matthew Allen Sommerfield, Allentown, PA (US)

(73) Assignee: Kensol AutoMist LLC, Coplay, PA (US)

(21) Appl. No.: 18/675,747

(22) Filed: May 28, 2024

(51) Int. Cl. F24C 15/20; B05B 1/14; B08B 3/08; B08B 13/00

(52) U.S. Cl. CPC F24C 15/2057; B05B 1/14; B08B 3/08; B08B 13/00

(57) ABSTRACT

An apparatus and method for applying a grease dissolving fluid to the surfaces of a commercial range hood. Grease dissolving fluid from a tank is sprayed as a fine mist on surfaces coated with cooking grease to break down the cooking grease into oxygen, hydrogen and water vapor. The spraying process is executed by spraying a fine mist while the range hood fan is constantly running, and hard to clean areas like the upper duct and the lower side of the filters may be cleaned with ease. Use of a dump valve minimizes the dripping of the grease dissolving fluid onto cooking surfaces at the beginning and end of a spraying step.

### BACKGROUND

Range hoods are used above cooking surfaces to capture grease, common odors, and hazardous gases created during the cooking process. Typical range hoods are fitted with a filter for collecting grease out of cooking fumes, an air duct above said filter, and at least one vent fan in the air duct. The vent fan draws air from the cooking area through the filters and up the air duct to be exhausted out of the building.

As vaporized grease travels through the range hood, it condenses and adheres to every surface it comes into contact with. The filters are intended to collect most of the grease out of the air that passes through the filters. Some grease will get past the filter and condense on the inside walls of the air duct and the vent fan. As a result, both the filters and the air duct must be periodically cleaned due to grease buildup. Failing to clean grease buildup hinders the performance of the filters and creates fire and health hazards. Most range hoods are cleaned manually and the entire process is a dirty, messy job. Many commercial kitchens lack a commercial dishwasher, making the cleaning of the filters more difficult and labor-intensive.

Attempts have been made to automate the cleaning process. For example, one such system uses a plurality of spray nozzles positioned behind the filters and inside the air duct to automatically spray a degreasing agent on a predetermined schedule. The degreasing agent breaks down and reduces the surface tension of the condensed grease, causing a grease/degreaser mixture to release from the surfaces and collect in a tray. Although this system is an improvement over manual cleaning, it suffers from several deficiencies. The amount and type of type of grease dissolving fluid (a degreaser) dispensed through the spray nozzles results in the released grease/degreaser mixture dripping downwardly from treated surfaces. In order to avoid grease/degreaser mixture from dripping onto cooking surfaces, collection trays are required, which adds cost and complexity to the system. In addition, some surfaces (such as the front side of the filters) cannot be treated using spray nozzles because it is not feasible to provide a properly positioned collection tray. Finally, a significant volume of grease/degreaser mixture is generated from this cleaning process, which must be disposed of and results in the need to periodically clean the collection trays. Accordingly, there is a need for a grease removal method and apparatus that enables more comprehensive cleaning of range hood surfaces and addresses other deficiencies of prior art systems.

### SUMMARY

Disclosed herein is an automated system and method for reducing the build-up of grease on surfaces of a commercial range hood and makes grease much easier to remove from those surfaces. The system is arranged to be situated on the wall adjacent to the range hood to supply a grease dissolving fluid inside the ventilation duct and on the hood filters, preferably including the front side of the hood filters. The system includes multiple fluid supply conduits with a pump, valves, and nozzles to apply grease dissolving fluid at the desired locations. The grease dissolving fluid used with the system is preferably biologically enhanced and adapted to break down cooking grease into hydrogen, oxygen, and water.

A supply tank is included to store grease dissolving fluid ahead of the cleaning cycle and to collect any fluid remaining in the conduits at the end of the cycle. A controller is used to monitor time, fluid level in the tank, pump pressure, and duct pressure while operating the pump power, valves, and optionally the duct fan. The controller periodically checks for negative pressure in the duct, to confirm that the duct fan above the range hood filters is running during a portion of the cleaning cycle in which nozzles located in front of the hood filters are active. In some implementations, if any of the four controller inputs are outside the desired parameters, then the cycle stops or will not start as scheduled and the user is notified.

In addition, dump valves are opened for a short interval at the end of each spraying period. This minimizes dripping of grease dissolving fluid onto cleaning surfaces, as well as maintaining grease dissolving fluid in the conduit that supply the spray nozzles, in order to minimize dripping and sputtering when the next spray period is initiated.

### BRIEF DESCRIPTION OF THE DRAWINGS

For a more complete understanding of the present invention, reference is made to the following detailed description of embodiments considered in conjunction with the accompanying drawings, in which:

FIG. 1 is a schematic drawing of the range hood cleaning system with the range hood and cooking surface in detail where fan control is not integrated with the invention.

FIG. 2 is a schematic drawing of the range hood cleaning system with the range hood and cooking surface in detail where fan control is integrated with the invention.

FIG. 3 is a control flow chart for monitoring the level of grease dissolving fluid in the tank.

FIG. 4 is a control flow chart for monitoring the pump pressure within a conduit.

FIG. 5 is a control flow chart for monitoring the pressure within the duct above the hood filters.

FIG. 6 is a control flow chart for monitoring the pressure within the duct above the hood filters where the duct fan is integrated with the system controller.

FIG. 7 is a control flow chart for an exemplary filter cleaning cycle.

FIG. 8 is a control flow chart for an exemplary duct cleaning cycle.

FIG. 9 is a control flow chart for an exemplary combined cleaning cycle.

### DETAILED DESCRIPTION OF THE PREFERRED EMBODIMENT(S)

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention.

In order to aid in describing the invention, directional terms may be used in the specification and claims to describe portions of the present invention (e.g., upper, lower, left, right, etc.). These directional terms are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

Unless otherwise indicated, the articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

The term “conduit,” as used in the specification and claims, refers to one or more structures through which fluids can be transported between two or more components of a system. For example, conduits can include pipes, ducts, passageways, and combinations thereof that transport liquids, vapors, and/or gases.

As used in the specification and claims, the terms “flow communication” or “fluid flow communication” are intended to mean that two or more elements are connected (either directly or indirectly) in a manner that enables fluids to flow between the elements, including connections that may contain valves, gates, tees, or other devices that may selectively restrict, merge, or separate fluid flow.

The term “commercial range hood”, as used in the specification and claims, refers to a range hood located above a cooking surface comprising filters, a duct located above the filters and a duct fan located within the duct (typically at or near the outlet end of the duct). The filters comprise a lower and an upper side, where the upper side is facing upward toward the duct and the lower side is facing downward toward the cooking surface.

The term “grease dissolving fluid”, as used in the specification and claims, refers to a biologically enhanced, surfactant-based compound with a neutral pH. The grease dissolving fluid is non-toxic, non-hazardous and food-safe.

The term “cooking grease”, as used in the specification and claims, refers to the grease deposited on the surfaces of a commercial range hood by grease laden vapors traveling through the filters and up the duct. These vapors are produced from cooking and standard kitchen operation.

The term “outputs”, as used in the specification and claims, refers to any component that receives and responds to a signal sent by a controller.

The term “inputs”, as used in the specification and claims, refers to any component that sends a signal to a controller to relay information from a sensor.

The term “treated grease”, as used in the specification and claims, refers to any cooking grease that has had the grease dissolving fluid applied to it via direct contact.

The term “food safe”, as used in the specification and claims, defines a substance that may be in contact with food without any risk of contamination, food poisoning or any other negative human health effects.

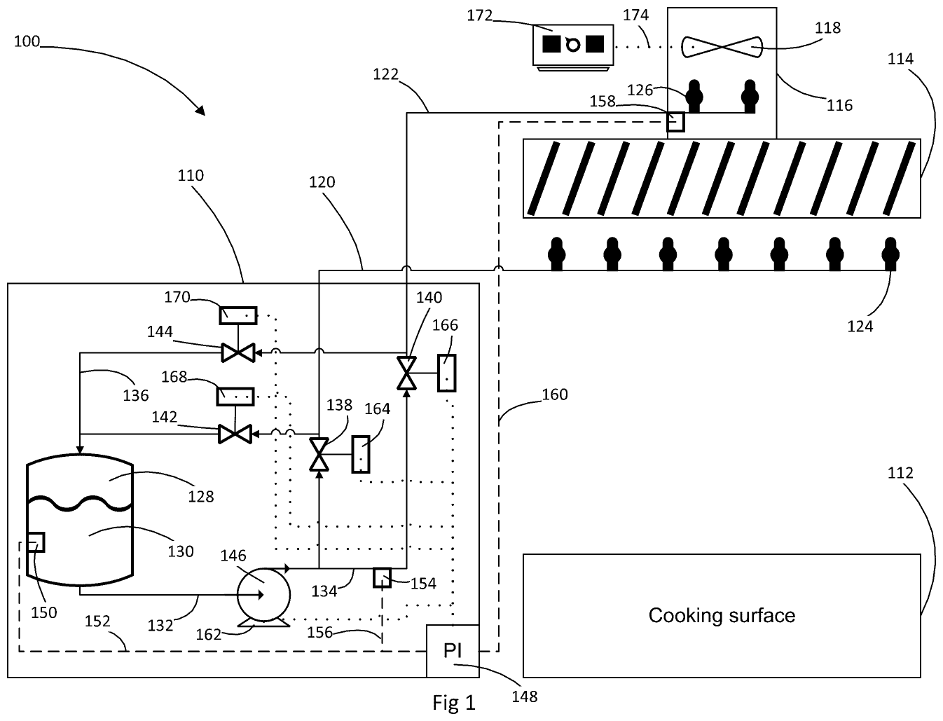

Referring to FIG. 1, an exemplary implementation of a system 100 for applying a grease dissolving fluid to the surfaces of a commercial range hood is shown. Most cleaning system components are contained within a housing 110 that is preferably positioned in close proximity to a cooking surface 112 and hood filters 114, but also positioned to minimize obstruction of the cooking work area. The hood filters 114 are located within a range hood (not shown) that narrows into a duct 116 for exhausting kitchen vapors from the building. The duct 116 is positioned above the hood filters 114. A fan 118 (typically located at or near the outlet end of the duct 116) provides airflow to draw air upwardly through the duct 116. The fan 118 is electrically coupled to a fan control 172, which provides either manual or automatic control over fan operation. In other implementations, more than one fan 118 could be provided.

Grease dissolving fluid 130 is stored in a supply tank 128 located inside the housing 110. The supply tank 128 is manually filled and must be maintained at an adequate fluid level. A pump 148 is coupled to the supply tank 128 in downstream fluid flow communication via a tank conduit 132. A filter spray valve 138 and a duct spray valve 140 are coupled to the pump 148 in downstream fluid flow communication via a pump conduit 134. A filter nozzle manifold 124 and a filter dump valve 142 are coupled to the filter spray valve 138 in downstream fluid flow communication via a filter conduit 120. A duct nozzle manifold 126 and a duct dump valve 144 are coupled to duct spray valve 140 in downstream fluid flow communication via duct conduit 122.

Each fluid path (filter or duct) splits off from pump conduit 138 to spray different components of the range hood with a corresponding nozzle manifold and dump valve. In some implementations, the duct nozzle manifold 126 and the filter nozzle manifold 124 many be operated differently and independently. The invention is not limited in the quantity of flow paths with spray valves, dump valves, and nozzle manifolds. Dump valves 142 and 144 are coupled with the supply tank 128 in upstream fluid flow communication via a dump conduit 136. Dump conduit 136 rejoins both fluid paths to return any unused grease dissolving fluid to supply tank 128 and prevent drippage from the nozzles after a cleaning cycle.

Each nozzle is preferably adapted to provide a spray having droplet size that is no larger than a fine mist. In other words, the nozzles preferably spray the grease dissolving fluid with a volume median diameter droplet size of no more than 150 microns, more preferably no more than 100 microns, and, most preferably, no more than 60 microns. Providing a relatively fine spray aids in having the sprayed grease dissolving fluid adhere to surfaces to be cleaned, being carried upwardly by the airflow through the duct 116, and minimizes dripping of the grease dissolving fluid on cooking surfaces.

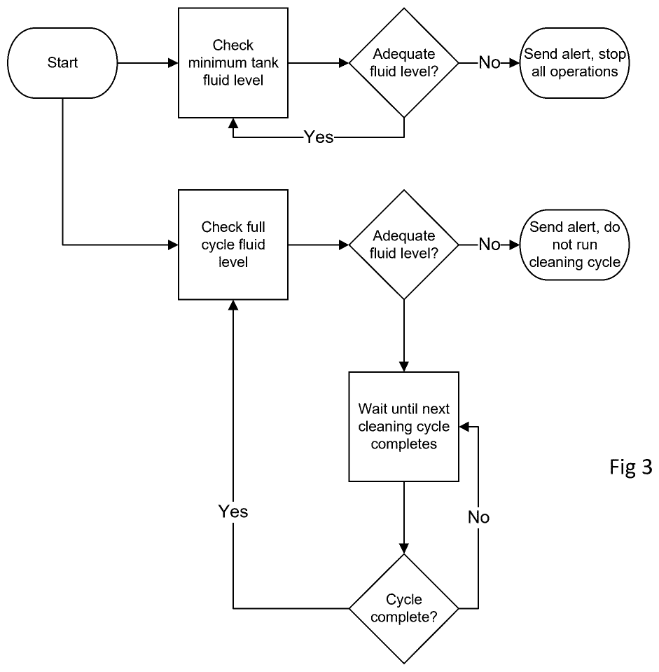

In the implementation depicted in FIG. 1, a controller 148 is included in the housing 110 to monitor the system and automatically execute the cleaning cycle. Controller 148 is coupled to fluid level sensor 150 inside supply tank 128 to provide feedback. When low levels of fluid are detected, the controller 148 notifies the user and acts according to the flowchart depicted in FIG. 3. In an exemplary implementation, fluid level sensor 150 preferably checks the fluid level in the supply tank 128 relative to two thresholds: (a) the amount of fluid needed to complete a full cleaning cycle and (b) a lower, “nearly empty” fluid level.

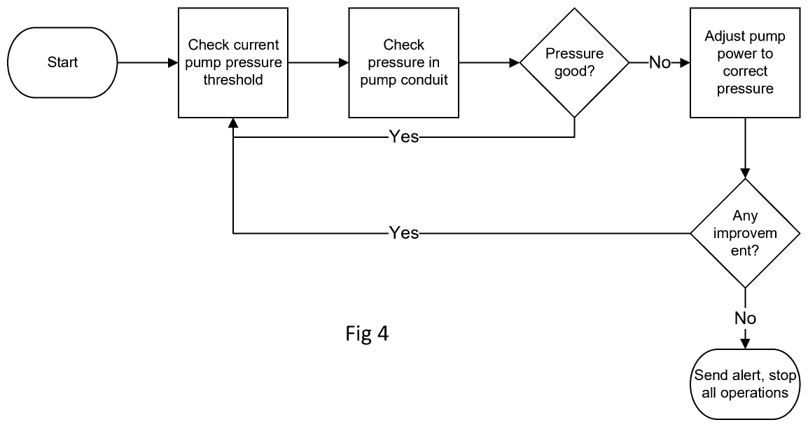

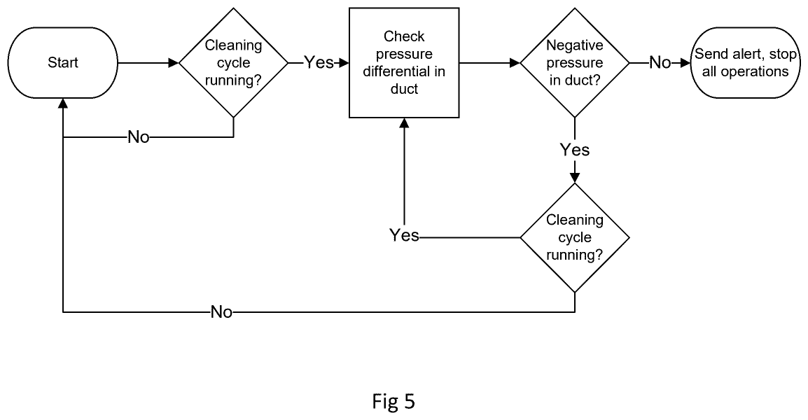

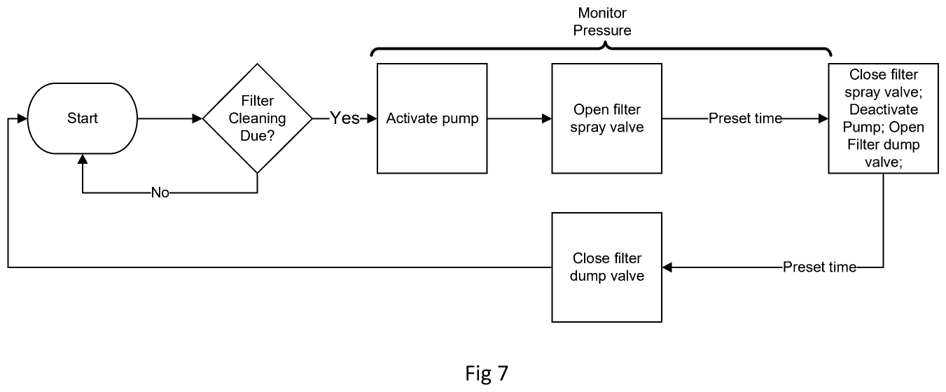

A pump pressure sensor 154 is located inside pump conduit 134 and coupled to controller 148 to provide pressure feedback. Additionally, pump output 162 establishes a PI feedback loop between controller 148 and pump 146. Controller 148 is also configured to shut down the cleaning cycle if efforts to correct an error do not yield desirable results. This functionality is further depicted in FIG. 4. A duct pressure sensor 158 is located inside the duct 116 above the hood filters 114 and coupled to controller 148 to provide feedback during the cleaning cycle. The controller 148 preferably monitors the pressure differential according to FIG. 5. This enables the controller 148 to active the filter nozzle manifold 124 only when the fan 118 is running. The means for detecting that the fan 118 is operating could include a pressure sensor (to detect airflow through the duct 116), a voltage or current sensor (to detect current flowing to the fan 118), or a motion sensor (to detect movement of the fan 118). Valve outputs 164, 166, 168, and 170 couple the controller 148 to each respective valve depicted in FIG. 1 to automatically run the cleaning cycle from start to finish. This functionality is disclosed in further detail in FIG. 7.

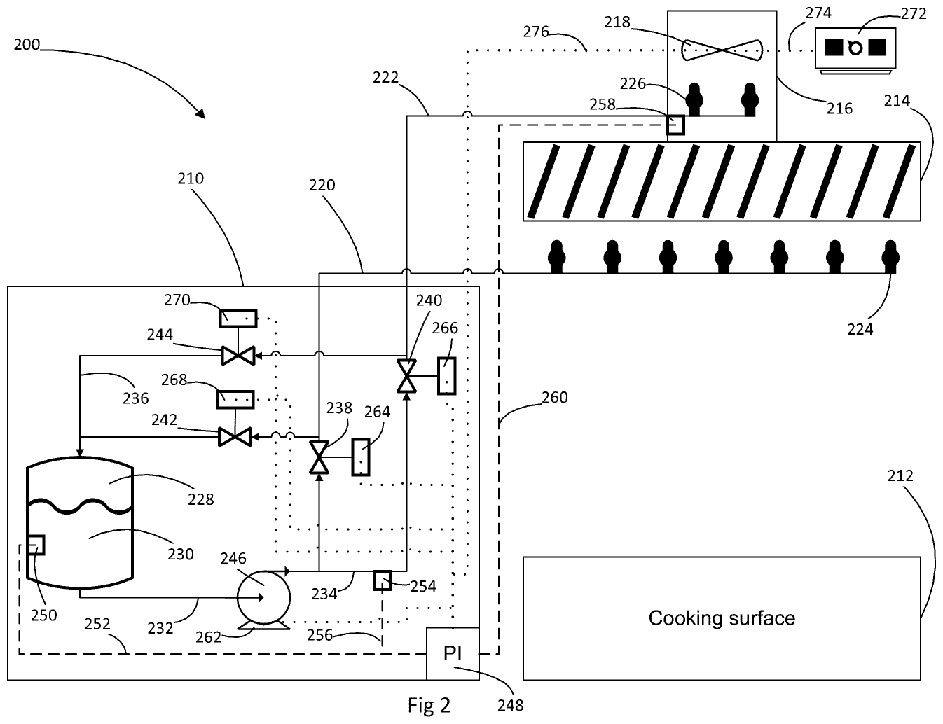

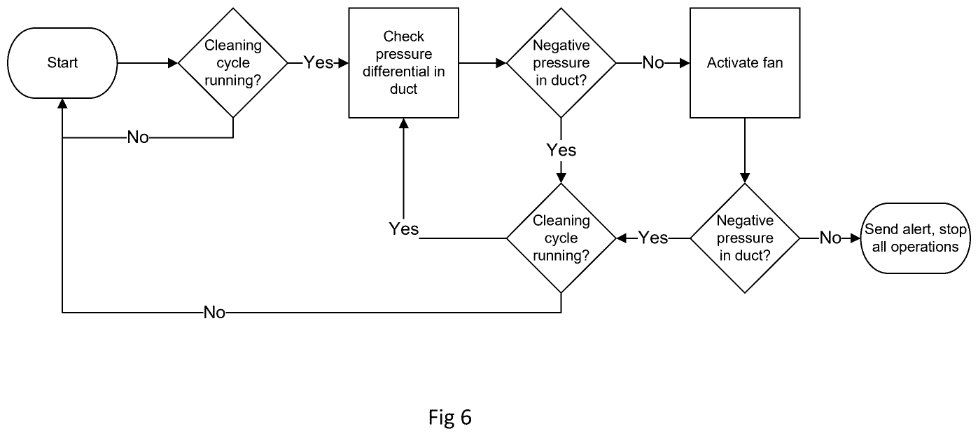

In the implementation depicted in FIG. 2, the elements are identical to FIG. 1 except a controller 248 is further integrated with a fan 218 via controller fan output 276. Output 276 establishes a feedback loop between controller 248 and fan 218 to provide more automatic functionality. This is depicted in the flow chart in FIG. 6. A manual switch 242 is still present to maintain a manual override for controller 248.

Referring to FIG. 3, a flow chart detailing an exemplary controller function for monitoring the level of grease dissolving fluid in the supply tank 128 is shown. Both fluid level thresholds: the level before the supply tank 128 is empty and the level required for one full cleaning cycle, are periodically monitored in parallel using input from fluid level sensor 150 in FIG. 1. If the sensor detects an inadequate amount of grease dissolving fluid for a full cycle, then the cycle will not start at the next scheduled time and the user is notified. If the sensor 150 detects a fluid level below the minimum amount required to avoid dry running the pump 146, then the controller 148 will stop all operations and notify the user.

Referring to FIG. 4, a flow chart detailing an exemplary controller 148 function for monitoring the pump pressure in pump conduit 134 from FIG. 1 is shown. Pump pressure sensor 154 monitors the internal pressure of pump conduit 134 and provides input to the controller 148, while the controller 148 has output control over the pump 146 to complete a feedback loop. If the measured pressure falls outside of the desired threshold, the controller 148 will first try to adjust the pump duty to correct. If the system falls too far outside the threshold or the feedback loop fails to improve the measured error, then the controller 148 will stop all operations and notify the user.

Referring to FIG. 5, a flow chart detailing the controller 148 function for monitoring the pressure within the duct 116 above the hood filters 114 is shown. While a cleaning cycle is active and grease dissolving fluid is being applied via the filter nozzle manifold 124, it is preferable that the duct fan 118 be running. Duct pressure sensor 158 periodically checks for a negative duct pressure during the cleaning cycle. If at any time during the cycle the pressure is not negative indicating the fan is off, then the controller will stop all operations and notify the user.

FIG. 6 contains all the details of FIG. 5 with the fan being integrated with the controller 148 to provide an output. If the duct pressure sensor 158 does not detect a negative pressure in the duct, controller 148 will attempt to turn on fan 118 before stopping all operations and notifying the user.

Referring to FIG. 7, a flow chart detailing an exemplary implementation of a filter cleaning cycle is shown. Component reference numerals will refer to the schematic depicted in FIG. 1. A filter cleaning cycle will only begin at a scheduled time and when controller 148 detects no problems with any input signals. In order to initiate a filter cleaning cycle, pump 146 is activated and grease dissolving fluid 130 is withdrawn from the bottom of supply tank 128 via tank conduit 132. The filter spray valve 138 is opened to allow pressurized grease dissolving fluid 130 to pass through the pump conduit 134, the filter conduit 120 and the filter nozzle manifold 124 to spray a fine mist on the surfaces of the hood filters 114. During spraying, the filter dump valve 142 is closed. In addition, during the period of time in which the pump 146 is operating, pressure in the pump conduit 134 is monitored (as described above in connection with FIG. 4). If pressure is insufficient, an alert is sent and the pump 146 is deactivated.

After a predetermined period of time, the pump 146 is deactivated, the filter dump valve 142 is opened, and the filter spray valve 138 is closed. This stops the spraying and allows grease dissolving fluid in the filter conduit 120 to flow back to the tank 128 and away from the spray nozzles in the filter nozzle manifold 124. The minimizes any dripping of the grease dissolving fluid onto the cooking surface. The filter dump valve 142 is open for a very short period of time (typically less than a second), then closed so that most of the filter conduit 120 is still filled with grease dissolving fluid. This reduces dripping and sputtering from the spray nozzles in the filter nozzle manifold 124, in order to minimize grease dissolving fluid from ending up on cooking surfaces.

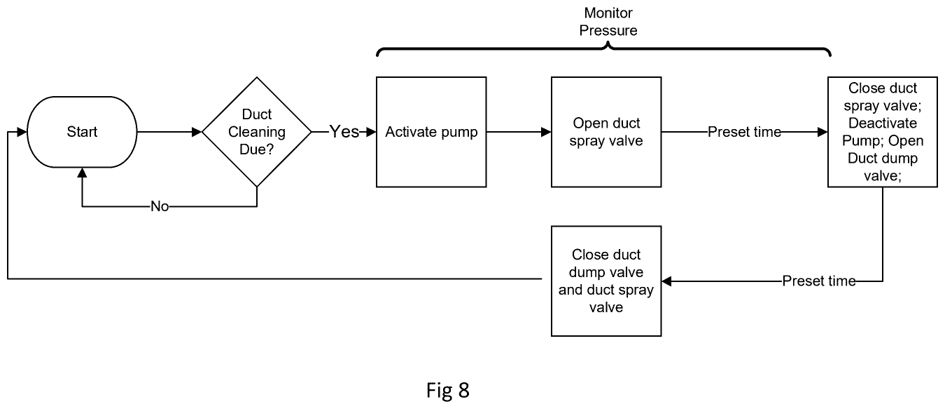

Similarly, in the implementation depicted in FIG. 8, to execute a duct cleaning cycle, the duct spray valve 140 is opened. This allows pressurized grease dissolving fluid 130 to pass through pump conduit 134, duct conduit 122 and duct nozzle manifold 126 to spray a fine mist on the surfaces of duct 116. During the period of time in which the pump 146 is operating, pressure in the pump conduit 134 is monitored (as described above in connection with FIG. 4). If pressure is insufficient, an alert is sent and the pump 146 is deactivated.

After a predetermined time period, the duct dump valve 144 is opened to redirect the pressurized grease dissolving fluid back to the tank 128 and stop spraying, the pump 146 is deactivated and the duct dump valve 144 and duct spray valve 140 are closed. The system 110 then waits for the next scheduled time to execute a cycle. The entire process is automatically run by the controller 148, and the apparatus is not limited to only two locations (hood filter and duct) for spraying.

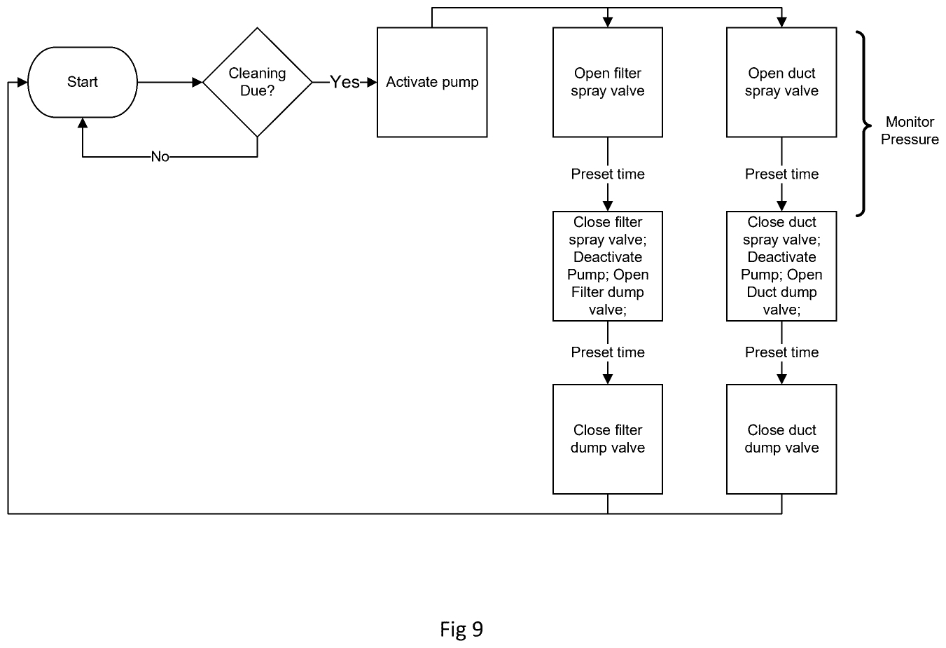

FIGS. 7 and 8 illustrate filter and duct cleaning cycles that are run independently and do not overlap. FIG. 9 shows an exemplary implementation in which the duct and filter cleaning cycles overlap. In this exemplary implementation, when the pump is activated, both the filter spray valve 138 and the duct spray valve 140 are opened. When each respective spray time has ended, the pump 146 is deactivated, the applicable spray valves are closed, and the applicable dump valves are opened for a period of time, then closed.

Many operating schedules are possible. As noted above, filter and duct cleaning cycles may be run on different schedules because the cleaning needs of the hood filters 114 and duct 116 may be different. The filter spray valve 138 and duct spray valve 140 could be opened and/or closed at different times in order to accommodate different spray times for the filter nozzle manifold 124 and duct nozzle manifold 126. For example, the filter cleaning cycle could be shorter than the duct cleaning cycle. In addition, in some implementations, the nozzles of the duct nozzle manifold may have larger orifices that the nozzles of the filter nozzle manifold.

In an implementation of a system very similar to the system 100 shown in FIG. 1, and operated similarly to the methods described in FIGS. 3-8, grease buildup on the filters 114 was greatly reduced and the filters 114 were able to be fully cleaned with relatively brief hot water rinse. Without use of the system 100, fully cleaning the filters 114 would require use of a degreaser, detergent, and hot water, along with much more rigorous scrubbing. Similarly, prior to use of the system 100, the duct 116 areas (including the plenum and vent) required cleaning every 1-2 months due to grease build-up. After implementing the system 100, the duct 116 area has remained largely grease-free and has not required cleaning for several months.

1. A system for reducing buildup and facilitating removal of cooking grease from a commercial range hood having a vent fan, a vent duct, at least one filter, the system comprising:
a tank that contains a grease dissolving fluid, the grease dissolving fluid being a biologically enhanced, surfactant-based compound having a neutral pH;
a pump in downstream fluid flow communication with the tank;
at least one nozzle manifold in downstream fluid flow communication with the pump, each at least one nozzle manifold comprising at least one nozzle positioned and oriented to spray the grease dissolving fluid onto at least one cleaning surface of the commercial range hood;
a controller adapted to selectively energize the pump and to control at least one valve that enables the grease dissolving fluid to be sprayed onto the at least one cleaning surface.

2. The system of claim 1, wherein the at least one nozzle is adapted to provide a spray of the grease dissolving fluid having a volume median diameter droplet size of no more than 150 microns.

3. The system of claim 1, wherein the grease dissolving fluid is adapted to break down cooking grease into hydrogen, oxygen, and water.

4. The system of claim 1, wherein the controller is adapted to selectively energize the pump and control the at least one valve based on a predetermined schedule.

5. The system of claim 1, wherein the at least one nozzle manifold comprises a filter nozzle manifold having a plurality of nozzles positioned and oriented to direct a spray onto a front surface of a vent filter of the commercial range hood, the front surface being angled downwardly and facing a cooking surface located below the commercial range hood.

6. The system of claim 5, further comprising means for detecting that the vent fan is running.

7. The system of claim 6, wherein the controller is adapted to initiate flow of the grease dissolving fluid to the filter nozzle manifold only when the controller detects that the vent fan is running.

8. The system of claim 6, wherein the controller is adapted to terminate flow of the grease dissolving fluid if the controller detects that the vent fan has stopped running.

9. The system of claim 5, wherein the controller is adapted to activate the vent fan prior to initiating flow of the grease dissolving fluid to the filter nozzle manifold.

10. The system of claim 5, wherein the at least one nozzle manifold comprises a duct nozzle manifold having a plurality of nozzles positioned and oriented to direct a spray onto the vent duct.

11. A method for removing cooking grease from a commercial range hood having a vent fan, a vent duct, and at least one filter, the method comprising:
(a) spraying a grease dissolving fluid onto at least one cleaning surface of the commercial range hood using a first nozzle manifold having at least one first spray nozzle, wherein the grease dissolving fluid is a biologically enhanced, surfactant-based compound having a neutral pH; and
(b) initiating and terminating step (a) using a controller that adapted to initiate step step (a) in accordance with a first predetermined time schedule and to perform step (a) for a first predetermined period of time.

12. The method of claim 11, wherein the at least one first spray nozzle is positioned to spray the grease dissolving fluid onto a front side of the at least one filter, the front side facing downwardly toward a cooking surface.

13. The method of claim 12, further comprising:
(c) initiating step (a) only if the controller detects that the vent fan is running.

14. The method of claim 12, further comprising:
(d) terminating step (a) if the controller detects that the vent fan has stopped running during the performance of step (a).

15. The method of claim 12, further comprising:
(e) activating the vent fan using the controller before initiating step (a).

16. The method of claim 15, further comprising:
(f) causing the vent fan to continue running during the entire duration of step (a).

17. The method of claim 11, wherein the grease dissolving fluid sprayed in step (a) has a volume median diameter droplet size of no more than 150 microns.

18. The method of claim 11, further comprising:
(g) spraying the grease dissolving fluid onto at least one cleaning surface of the commercial range hood using a second nozzle manifold having at least one second spray nozzle; and
(h) initiating and terminating step (g) using the controller, the controller being adapted to initiate step (g) in accordance with a second predetermined time schedule and to perform step (g) for a second predetermined period of time.

19. The method of claim 18, wherein the at least one second spray nozzle is positioned to spray the grease dissolving fluid onto the vent duct.

20. The method of claim 18, wherein the second predetermined time schedule is different from the first predetermined time schedule.

21. The method of claim 18, wherein the second predetermined period of time is different from the first predetermined period of time.

22. The method of claim 11, further comprising, repeatedly performing step (a) without performing a rinse cycle between each performance of step (a).

23. The method of claim 18, further comprising, repeatedly performing step (g) without performing a rinse cycle between each performance of step (g).

24. A method for reducing buildup and facilitating removal of cooking grease from a commercial range hood having a vent fan, a vent duct, and at least one filter, the method comprising:
(a) providing a pump that is in downstream fluid flow communication with a tank containing a supply of a grease dissolving fluid and in upstream fluid flow communication with a manifold containing at least one opening a spray valve;
(b) providing at least one nozzle manifold in downstream fluid flow communication with the pump, each at least one nozzle manifold comprising at least one nozzle positioned and oriented to spray the grease dissolving fluid onto at least one cleaning surface of the commercial range hood;
(c) providing a first valve that, when closed, isolates the manifold from the pump;
(d) providing a second valve that, when open, enables grease dissolving fluid in the manifold to flow into the tank;
(e) providing a controller adapted to selectively energize the pump and to selectively open and close the first valve and the second valve;
(f) activating the pump and opening the first valve for a first predetermine time period, resulting in the grease dissolving fluid being sprayed from the at least on spray nozzle onto at least one cleaning surface of the commercial range hood;
(g) after performing step (f), deactivating the pump, closing the first valve, and opening the first valve for a second period of time, the second period of time being adapted to result in a portion of the grease dissolving fluid contained within the manifold at the conclusion of step (f) to drain from the manifold into the tank.
